(19) United States
(12) Patent Application Publication
(10) Pub. No.: US 2026/0203903 A1
(43) Pub. Date: Jul. 16, 2026

(54) BODY PART IMAGE GENERATION

(71) Applicant: Tencent Technology (Shenzhen) Company Limited, Shenzhen (CN)

(72) Inventor: Lei SHEN, Shenzhen (CN)

(73) Assignee: Tencent Technology (Shenzhen) Company Limited, Shenzhen (CN)

(21) Appl. No.: 19/559,795

(22) Filed: Mar. 6, 2026

Related U.S. Application Data
(63) Continuation of application No. PCT/CN2024/114507, filed on Aug. 26, 2024.

(30) Foreign Application Priority Data
Nov. 7, 2023 (CN) 202311477170.4

(51) Int. Cl. G06T 7/00; G06T 5/70; G06T 11/10; G06V 10/54; G06V 10/80

(52) U.S. Cl. CPC G06T 7/0012; G06T 5/70; G06T 11/10; G06V 10/54; G06V 10/806; G06T 2207/20081; G06T 2207/30004

(57) ABSTRACT

In a body part image generation method, a body part texture image is obtained. The body part texture image indicates a texture of a body part in a body part image to be generated. Body part posture information is obtained. The body part posture information indicates a posture of the body part in the body part image to be generated. A Gaussian noise image is obtained. Gaussian noise is iteratively predicted based on the body part texture image and the body part posture information. A body part image is generated, by processing circuitry, through iterative denoising of the Gaussian noise image based on the iteratively predicted Gaussian noise. Apparatus and non-transitory computer-readable storage medium counterpart embodiments are also contemplated.

### RELATED APPLICATIONS

The present application is a continuation of International Application No. PCT/CN2024/114507, filed on Aug. 26, 2024, which claims priority to Chinese Patent Application No. 202311477170.4, filed on Nov. 7, 2023. The entire disclosures of the prior applications are hereby incorporated by reference.

### FIELD OF THE TECHNOLOGY

This disclosure relates to the field of artificial intelligence technologies, including a body part image generation method, a body part image generation apparatus, an electronic device, a computer-readable storage medium, and a computer program product.

### BACKGROUND OF THE DISCLOSURE

A generative model is a technology that has attracted significant attention in the field of artificial intelligence in recent years. The generative model not only can be applied to fields such as speech synthesis and image generation, but also can be applied to aspects such as natural language processing and machine translation.

As an important application of the generative model, image generation may be configured to generate various types of images, for example, a facial image, artistic paintings, and body images. Different generative models may be used based on different image generation requirements.

However, in the related art, during generation of a body part image through a generative model, for example, during generation of a palm image, focus is placed only on texture quality, and the generated body part image can only meet requirements for the texture quality. To generate body part images that satisfy more requirements, additional training is required, which consumes extra resources.

### SUMMARY

Embodiments of this disclosure provide a body part image generation method, a body part image generation apparatus, an electronic device, a computer-readable storage medium, and a computer product.

According an aspect, this disclosure provides a body part image generation method. In the body part image generation method, a body part texture image is obtained. The body part texture image indicates a texture of a body part in a body part image to be generated. Body part posture information is obtained. The body part posture information indicates a posture of the body part in the body part image to be generated. A Gaussian noise image is obtained. Gaussian noise is iteratively predicted based on the body part texture image and the body part posture information. A body part image is generated by processing circuitry through iterative denoising of the Gaussian noise image based on the iteratively predicted Gaussian noise.

According an aspect, this disclosure provides an information processing apparatus including processing circuitry. The processing circuitry is configured to obtain a body part texture image. The body part texture image indicates a texture of a body part in a body part image to be generated. The processing circuitry is configured to obtain body part posture information. The body part posture information indicates a posture of the body part in the body part image to be generated. The processing circuitry is configured to obtain a Gaussian noise image. The processing circuitry is configured to iteratively predict Gaussian noise based on the body part texture image and the body part posture information. The processing circuitry is configured to generate a body part image through iterative denoising of the Gaussian noise image based on the iteratively predicted Gaussian noise.

According an aspect, this disclosure provides a non-transitory computer-readable storage medium storing instructions which when executed by at least one processor cause the at least one processor to perform a body part image generation method. In the body part image generation method, a body part texture image is obtained. The body part texture image indicates a texture of a body part in a body part image to be generated. Body part posture information is obtained. The body part posture information indicates a posture of the body part in the body part image to be generated. A Gaussian noise image is obtained. Gaussian noise is iteratively predicted based on the body part texture image and the body part posture information. A body part image is generated by processing circuitry through iterative denoising of the Gaussian noise image based on the iteratively predicted Gaussian noise.

According to an aspect, this disclosure provides a body part image generation method, performed by an electronic device, and including: obtaining a body part texture image, the body part texture image indicating a texture of a body part image expected to be generated; obtaining body part posture information, the body part posture information indicating a posture of the body part image expected to be generated; obtaining a Gaussian noise image; and iteratively predicting Gaussian noise based on the body part texture image and the body part posture information, and performing iterative denoising on the Gaussian noise image through the iteratively predicted Gaussian noise to generate a body part image.

According to an aspect, this disclosure provides a body part image generation apparatus, including: a texture obtaining module, configured to obtain a body part texture image, the body part texture image indicating a texture of a body part image expected to be generated; a posture obtaining module, configured to obtain body part posture information, the body part posture information indicating a posture of the body part image expected to be generated; a noise obtaining module, configured to obtain a Gaussian noise image; and an image denoising module, configured to iteratively predict Gaussian noise based on the body part texture image and the body part posture information, and perform iterative denoising on the Gaussian noise image through the iteratively predicted Gaussian noise to generate a body part image.

According to an aspect, this disclosure provides an electronic device including a memory and a processor, the memory having a computer program stored therein, and the processor being configured to execute the computer program in the memory to implement the operations of the body part image generation methods provided in this disclosure.

According to an aspect, this disclosure provides a computer-readable storage medium, such as a non-transitory computer-readable storage medium, having a computer program stored therein, the computer program being adapted to be run by a processor to implement the operations of the body part image generation methods provided in this disclosure.

According to an aspect, this disclosure provides a computer program product, including a computer program, the computer program being adapted to be run by a processor to implement the operations of the body part image generation methods provided in this disclosure.

Details of one or more embodiments of this disclosure are provided in the accompanying drawings and descriptions below. Other features, objectives, and advantages of this disclosure become apparent from the specification, the accompanying drawings, and the claims.

### BRIEF DESCRIPTION OF THE DRAWINGS

To describe the technical solutions in the embodiments of this disclosure more clearly, the following briefly describes the accompanying drawings. The accompanying drawings in the following descriptions show merely some embodiments of this disclosure, and a person of ordinary skill in the art may still derive other drawings from these accompanying drawings.

FIG. 1 is a schematic diagram of a scenario of an image processing system according to an embodiment of this disclosure.

FIG. 2 is a schematic flowchart of a body part image generation method according to an embodiment of this disclosure.

FIG. 3 is an example diagram of generating a body part image according to an embodiment of this disclosure.

FIG. 4 is a schematic structural diagram of a noise prediction model according to an embodiment of this disclosure.

FIG. 5 is another schematic structural diagram of a noise prediction model according an embodiment of this disclosure.

FIG. 6 is an example diagram of performing mapping on a virtual avatar model according to an embodiment of this disclosure.

FIG. 7 is another schematic flowchart of a body part image generation method according to an embodiment of this disclosure.

FIG. 8 is a schematic structural diagram of a body part image generation apparatus according to an embodiment of this disclosure.

FIG. 9 is a schematic structural diagram of an electronic device according to an embodiment of this disclosure.

### DESCRIPTION OF EMBODIMENTS

Technical solutions in embodiments of this disclosure are described below with reference to accompanying drawings in the embodiments of this disclosure. The described embodiments are merely some rather than all of the embodiments of this disclosure. Other embodiments are within the scope of this disclosure.

In the following description of this disclosure, the involved expression “some embodiments” describes subsets of all possible embodiments, but the expression “some embodiments” may be the same subset or different subsets of all the possible embodiments, and may be combined with each other without conflict.

In the following description of this disclosure, a term “first/second/third” involved is merely configured to distinguish between similar objects and does not represent a specific order of objects. “First/second/third” may be transposed for a specific order or a sequence when allowed, so that the embodiments of this disclosure described herein can be implemented in an order other than those illustrated or described herein.

In the following description of this disclosure, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used herein are the same as those usually understood by a person skilled in the art to which this disclosure belongs. The examples of terms used in this specification are merely intended to describe the objectives of the embodiments of this disclosure, and are not intended to limit this disclosure.

This disclosure relates to the technical field of generative models in artificial intelligence technologies, and provides a body part image generation method, a body part image generation apparatus, an electronic device, a computer-readable storage medium, and a computer program product. The body part image generation method may be performed by a body part image generation apparatus, or performed by an electronic device that integrates the body part image generation apparatus.

The technical solutions in the embodiments of this disclosure are described below with reference to accompanying drawings in the embodiments of this disclosure. The foregoing described embodiments are merely some rather than all of the embodiments of this disclosure. All other embodiments obtained by a person skilled in the art based on the embodiments of this disclosure are within the scope of this disclosure.

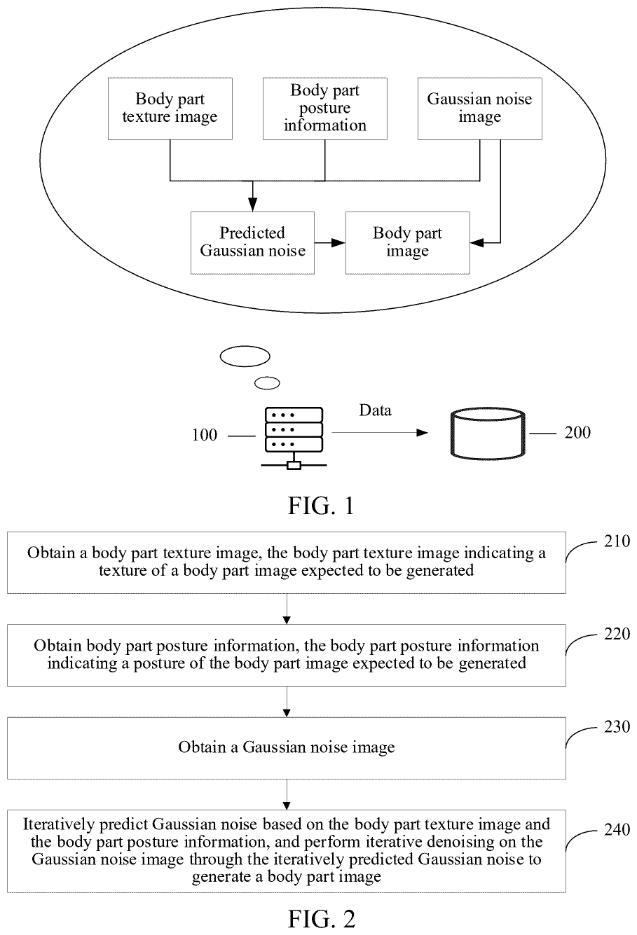

Referring to FIG. 1, this disclosure further provides an image processing system. The image processing system includes an electronic device 100, configured to perform the body part image generation method provided in this disclosure. The electronic device 100 may be any device configured with a processor and having a processing capability, such as a mobile device having a processor, such as a smartphone, a tablet computer, a palmtop computer, a notebook computer, a virtual reality device, an augmented reality device, or a mixed reality device, or a fixed device having a processor, such as a desktop computer, a television, a server, or an industrial device. The electronic device 100 may be configured to: obtain a body part texture image, the body part texture image indicating a texture of a body part image expected to be generated; obtain body part posture information, the body part posture information indicating a posture of the body part image expected to be generated; obtain a Gaussian noise image; and iteratively predict Gaussian noise based on the body part texture image and the body part posture information, and perform iterative denoising on the Gaussian noise image through the iteratively predicted Gaussian noise, to generate the body part image.

In addition, as shown in FIG. 1, the image processing system may further include a memory 200, configured to store relevant data in an image processing process, for example, a body part texture image, body part posture information, and Gaussian noise image that are obtained, predicted Gaussian noise, and a body part image finally generated through denoising.

The image processing system described above is merely an example, and is intended to describe the technical solutions of the embodiments of this disclosure more clearly, and does not constitute a limitation on the technical solutions provided in the embodiments of this disclosure. A person of ordinary skill in the art would understand that with the evolution of the image processing system and emergence of new service scenarios, the technical solutions provided in the embodiments of this disclosure are also applicable to similar technical problems.

Detailed descriptions are provided below. The following embodiments are not construed as a limitation on a preference order of the embodiments.

FIG. 2 is a schematic flowchart of a body part image generation method according to an embodiment of this disclosure. As shown in FIG. 2, a process of the body part image generation method may be as follows.

210: Obtain a body part texture image, the body part texture image indicating a texture of a body part image expected to be generated. In an example, a body part texture image is obtained. The body part texture image indicate a texture of a body part in a body part image to be generated.

The body part image is an image of a body part. The body part may include a human face or limbs. The limbs may include a palm or a sole of a foot. The body part texture image is an image describing a texture of the body part. For example, the body part image may be a palm print image. In this case, the palm print image may describe a texture of a palm print of a palm. The body part image may be a facial organ layout image. In this case, the facial organ layout image may describe a facial texture. The body part image expected to be generated is a body part image that is intended to be generated through processing of this disclosure. In this case, the body part image is not known, and an image of a texture of the body part image is obtained as a body part texture image.

The body part image generation method provided in this disclosure is adapted to generation of a body part image. During the generation, the texture and a posture of a body part are decoupled and generated, so as to generate a body part image with a controllable posture. Based on actual requirements, a body part image of a body part such as a palm, a sole, or a face may be generated.

A manner of obtaining the body part texture image is not specifically limited herein, which may be receiving an inputted body part texture image through an input component (such as a keyboard, a mouse, a touchscreen, or a touchpad), or may be collecting a body part texture image through an image collection component (such as a camera), or may be receiving a body part texture image sent by an external device, or the like.

220: Obtain body part posture information, the body part posture information indicating a posture of the body part image expected to be generated.

As described above, in this disclosure, to generate a body part image with a controllable posture, texture information for guiding generation of body part image texture and posture information for guiding generation of a body part image posture are respectively obtained. The body part posture information describes a posture of a body part in the body part image. For example, the body part posture information may be information representing a posture of a palm, which may specifically represent postures of five fingers and a palm portion of a palm. The posture of each of the fingers is for example bending or straightening, a posture of the palm is for example a palm orientation, or the like.

In this embodiment, the body part posture information indicating the posture of the body part image expected to be generated is further obtained. A manner of obtaining the body part posture information is not specifically limited herein, which may be receiving inputted body part posture information through an input component (such as a keyboard, a mouse, a touchscreen, or a touchpad), or may be collecting body part posture information through an image collection component (such as a camera), or may be receiving body part posture information sent by an external device, or the like.

For example, an inputted external body part image is received through the input component, and posture information of the external body part image is extracted as the body part posture information.

For another example, image collection is performed on an external object through an image collection component to collect an object image including at least a body part region of the external object, and body part posture information of the external object is extracted based on the object image.

230: Obtain a Gaussian noise image.

Gaussian noise refers to a type of noise whose probability density function follows a Gaussian distribution (i.e., normal distribution). Similar to salt and pepper noise, the Gaussian noise is also a common noise in a digital image. The salt and pepper noise is a noise that appears at random locations but has a relatively fixed noise depth, and the Gaussian noise is an opposite noise that appears at almost every location but has a random noise depth. As its name implies, the Gaussian noise image is an image whose content is pure Gaussian noise.

In some embodiments, the obtaining a Gaussian noise image includes: determining a target image size of the body part image expected to be generated; and obtaining the Gaussian noise image based on the target image size, an image size of the Gaussian noise image being consistent with the target image size.

In this embodiment, an electronic device may be configured to determine the target image size of the body part image expected to be generated, and obtain the Gaussian noise image whose image size is the target image size. The target image size may include a length and a width of the body part image. A manner of obtaining the target image size is not specifically limited herein, and may be receiving an inputted target image size through an input component (such as a keyboard, a mouse, a touchscreen, or a touchpad), or may be obtaining a default image size as the target image size, or the like.

As described above, after the target image size of the body part image expected to be generated is determined, a Gaussian noise image with an image size being the target image size is further obtained. The Gaussian noise image of the target image size may be generated in various manners. In other words, based on the target image size, a random noise matrix that follows a Gaussian distribution with a variance of 1 and a mean of 0 is generated, to obtain the Gaussian noise image of the target image size.

In this embodiment, it may be ensured that a size of a generated body part image conforms to an expected size, and free customization of a body part image of a desired size is allowed, thereby improving controllability of generating the body part image.

240: Iteratively predict Gaussian noise based on the body part texture image and the body part posture information, and perform iterative denoising on the Gaussian noise image through the iteratively predicted Gaussian noise to generate a body part image. In an example, the body part image is generated through iterative denoising of the Gaussian noise image based on the iteratively predicted Gaussian noise.

Specifically, the Gaussian noise image is used as an image generated by iteratively adding Gaussian noise to the body part image, the Gaussian noise iteratively added to the body part image is iteratively predicted based on the body part texture image and the body part posture information, and iterative denoising is performed on the Gaussian noise image through the iteratively predicted Gaussian noise, to generate the body part image.

In this embodiment, the electronic device may obtain Gaussian noise corresponding to the Gaussian noise image through the noise prediction model based on the body part texture image and the body part posture information, and denoise the Gaussian noise image based on the Gaussian noise, to generate the corresponding body part image. Specifically, the Gaussian noise image may be used as an image generated by iteratively adding Gaussian noise to the body part image. The Gaussian noise iteratively added to the body part image is iteratively predicted based on the body part texture image and the body part posture information through the noise prediction model, and iterative denoising is performed on the Gaussian noise image through the iteratively predicted Gaussian noise, to generate the body part image.

The noise prediction model is pre-trained in this embodiment. The noise prediction model is trained through a diffusion model. During the training of the noise prediction model, for a sample body part image with added Gaussian noise, the noise prediction model learns the ability to predict the added Gaussian noise based under the guidance of a sample body part texture image and sample body part posture information. In this way, in the application process, when a Gaussian noise image is inputted into the noise prediction model, the “added” Gaussian noise of the Gaussian noise image is predicted under the guidance of the body part texture image and the body part posture information. The “added” Gaussian noise is subtracted from the Gaussian noise image, so that a body part image whose texture conforms to the body part texture image and whose posture conforms to the body part posture information can be reconstructed.

Correspondingly, after the body part texture image indicating the texture of the body part image expected to be generated, reference posture information indicating a posture of the body part image expected to be generated, and the Gaussian noise image with the target image size are obtained, the body part texture image and the body part posture information are used as guidance. Through the pre-trained noise prediction model, the “added” Gaussian noise of the Gaussian noise image is predicted and denoted as Gaussian noise, and based on the Gaussian noise, the Gaussian noise image is denoised, i.e., the “added” Gaussian noise is subtracted therefrom, thereby obtaining a body part image whose texture conforms to the body part texture image and whose posture conforms to the body part posture information.

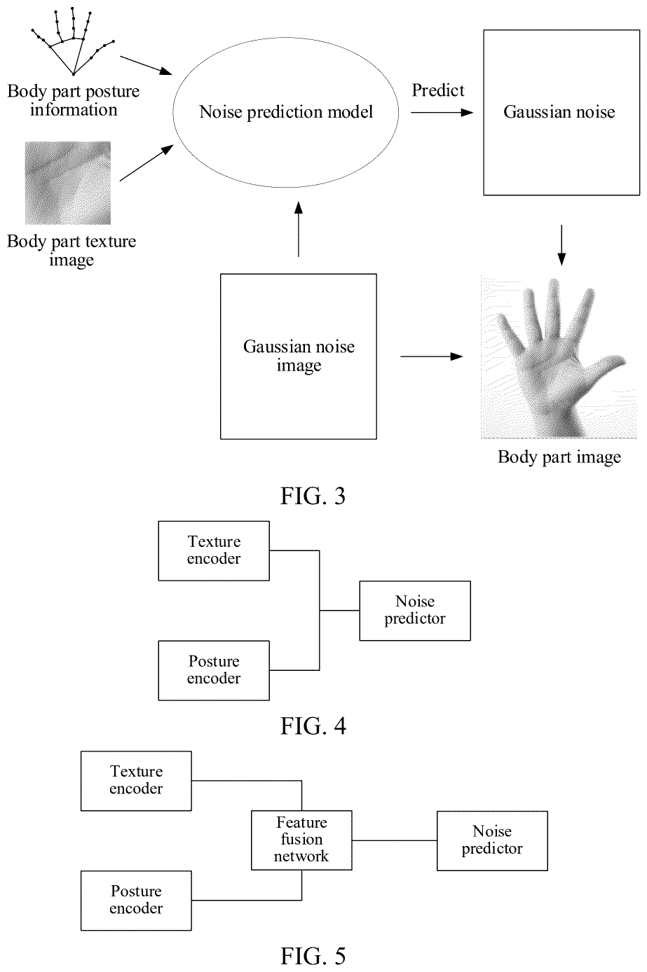

For example, referring to FIG. 3, generation of a palm image is used as an example. The obtained body part texture image is a palm image, and the obtained body part posture information is a palm key point position matrix. Under the guidance of the body part posture information and the body part texture image, the Gaussian noise added to the Gaussian noise image is predicted through the noise prediction model. Correspondingly, the Gaussian noise is subtracted from the Gaussian noise image, thereby obtaining a palm image whose texture conforms to the body part texture image and whose posture conforms to the body part posture information.

Through the foregoing body part image generation method, the texture of the body part may be specified, and a posture of the body part may be specified, thereby generating an image of the body part (i.e., a body part image) that conforms to the texture and the posture. This avoids training different models for realizing body part images with different postures, thereby avoiding a waste of resources. In addition, free customization of textures and postures is allowed, and a variety of body part images are generated through combinations of different textures and different postures, thereby achieving extremely high flexibility in practical applications.

In some embodiments, the iteratively predicting Gaussian noise based on the body part texture image and the body part posture information, and performing iterative denoising on the Gaussian noise image through the iteratively predicted Gaussian noise to generate a body part image includes: extracting a texture feature of the body part texture image, and extracting a posture feature of the body part posture information; and iteratively predicting the Gaussian noise based on the texture feature and the posture feature, and performing iterative denoising on the Gaussian noise image through the iteratively predicted Gaussian noise to generate the body part image.

Referring to FIG. 4, a noise prediction model may include a texture encoder, a posture encoder, a noise encoder (not shown in the figure), and a noise predictor. The texture encoder is configured to map an inputted body part texture image to a latent space to implement extraction of a texture feature of a body part texture image. The posture encoder is configured to map inputted body part posture information to the latent space to implement extraction of a posture feature of the body part posture information. The noise encoder is configured to map an inputted Gaussian noise image to the latent space to implement extraction of a noise distribution feature of a Gaussian noise image. The noise predictor is configured to predict, based on the noise distribution feature under the guidance of the texture feature and the posture feature, Gaussian noise added to the Gaussian noise image.

The latent space is a representation of compressed data, whose function is to learn data features and simplify data representation for the purpose of identifying patterns. An objective of data compression is to learn relatively important information in data, namely, learn how to store all related information and ignore noise, thereby removing redundant information and paying attention to the most crucial features. Such a compressed state is a representation of a latent space of data, namely, a feature, or referred to as a latent variable. As the name implies, “latent” means hidden, i.e., a variable or space without physical meaning, which lacks interpretability. For example, in a neural network, input data of an input layer and output data of an output layer are both real data in a physical world and have specific meanings. For example, the input data of this application, namely, the body part texture image and the body part posture information, has a specific meaning, and the output data, namely, the Gaussian noise, has a specific meaning.

In addition, network structures of the texture encoder, the posture encoder, and the noise predictor are not specifically limited in this embodiment, which may be configured by a person skilled in the art based on actual requirements.

In an example, the texture encoder is formed by connecting three residual blocks. The residual blocks are formed by connecting a convolutional layer, a normalization layer (or referred to as a batch normalization layer), and an activation function layer (such as, an ReLu function, namely a linear rectification function). The posture encoder is also formed by connecting three residual blocks. The noise encoder may also be formed by connecting three residual blocks. The noise predictor is obtained by connecting three deconvolution layers. For the texture encoder, features of different scales outputted from the three residual blocks may be respectively obtained as extracted texture features. For the posture encoder, a feature outputted from the last residual block may be obtained as a posture feature. For the noise encoder, a feature outputted from the last residual block may be obtained as a noise distribution feature.

In this embodiment, the obtained body part texture image may be inputted to the texture encoder of the noise prediction model, and the body part texture image may be mapped to a latent space through the texture encoder, thereby extracting a texture feature of a reference body part image. The obtained body part posture information may be inputted to the posture encoder of the noise prediction model, and the body part posture information may be mapped to the latent space through the posture encoder, thereby obtaining a posture feature of the body part posture information in advance. The obtained Gaussian noise image may be inputted to the noise encoder of the noise prediction model, and the Gaussian noise image may be mapped to the latent space through the noise encoder, thereby obtaining a noise distribution feature of the Gaussian noise image in advance. After the texture feature of the body part texture image, the posture feature of the body part posture information, and the noise distribution feature of the Gaussian noise image are extracted, the Gaussian noise “added” to the Gaussian noise image is further predicted through the noise encoder based on the noise distribution feature and under the guidance of the texture feature and the posture feature. Finally, the Gaussian noise is subtracted from the Gaussian noise image to generate a corresponding body part image.

In some embodiments, the iteratively predicting the Gaussian noise based on the texture feature and the posture feature, and performing iterative denoising on the Gaussian noise image through the iteratively predicted Gaussian noise to generate the body part image includes: fusing the texture feature and the posture feature to obtain a fused feature; predicting Gaussian noise of the Gaussian noise image at a T^{th} time step based on the fused feature, and denoising the Gaussian noise image based on the Gaussian noise at the T^{th} time step to obtain a denoised image at a (T−1)^{th} time step, T being a positive integer greater than 1; predicting Gaussian noise at a t^{th} time step of a denoised image at the t^{th} time step based on the fused feature, and denoising the denoised image at the t^{th} time step based on the Gaussian noise at the t^{th} time step to obtain a denoised image at a (t−1)^{th} time step, t∈[1, T−1]; and obtaining the body part image based on a denoised image at a 0^{th} time step.

Referring to FIG. 5, the noise prediction model further includes a feature fusion network. The feature fusion network is configured to fuse the inputted texture feature and posture feature to obtain a fused feature. A feature fusion manner of the feature fusion network is not limited herein, and may be selected by a person skilled in the art based on actual requirements.

In addition, the Gaussian noise image may be regarded as being obtained by adding Gaussian noise to the finally generated body part image at T time steps respectively. The noise predictor is intended to predict the Gaussian noise added to the body part image at each time step, thereby reversely subtracting the predicted Gaussian noise from the Gaussian noise image step by step over time, and finally obtaining the “original” body part image.

Correspondingly, in this embodiment, the texture feature of the body part texture image and the posture feature of the body part posture information are fused through the feature fusion network of the noise prediction model, to obtain the fused feature. The fused feature and a noise distribution feature of the Gaussian noise image are spliced and then inputted to the noise predictor, the Gaussian noise “added” to the Gaussian noise image at the T^{th} time step is predicted through the noise encoder based on the noise distribution feature of the Gaussian noise image and under the guidance of the fused feature, and the Gaussian noise “added” at the T^{th} time step is subtracted from the Gaussian noise image, to obtain the denoised image at the (T−1)^{-th} time step. The denoised image at the t^{th} time step is mapped to a latent space through the noise encoder of the noise prediction model, the noise distribution feature of the denoised image at the t^{th} time step is extracted, the fused feature and the noise distribution feature of the denoised image at the t^{th} time step are spliced and inputted to the noise predictor, Gaussian noise “added” at the (t−1)^{th} time step to the denoised image at the t^{th} time step is predicted through the noise encoder based on the noise distribution feature of the denoised image at the t^{th} time step and under the guidance of the fused feature, and the Gaussian noise “added” at the (t−1)^{th} time step is subtracted from the denoised image at the T^{th} time step, to obtain the denoised image at the (t−1)^{th} time step, where t∈[1, T−1]. In this way, a denoised image at a 0^{th} time step is finally obtained, and a corresponding body part image is obtained based on the denoised image at the 0^{th} time step. For example, the denoised image at the 0^{th} time step is directly used as a generated body part image. A value of T is a positive integer. A specific value of T is not limited herein, and may be configured by a person skilled in the art based on actual requirements. For example, in this embodiment, T is configured as 1000.

In some embodiments, the fusing the texture feature and the posture feature to obtain a fused feature includes: performing a cross-attention operation based on the texture feature and the posture feature to obtain an attention weight; and performing a weighting operation on the texture feature based on the attention weight to obtain the fused feature.

In this embodiment, the cross-attention operation may be performed based on the texture feature and the posture feature through the noise prediction model, to obtain the attention weight. The weighting operation is performed on the texture feature based on the attention weight through the noise prediction model, to obtain the fused feature.

This embodiment provides an attention-enhanced feature fusion manner. The cross-attention operation is performed through a feature fusion network of the noise prediction model based on the texture feature of the body part texture image and the posture feature of the body part posture information, to obtain the attention weight. Then, the weighting operation is performed on the texture feature through the feature fusion network of the noise prediction model based on the attention weight, to obtain the fused feature.

The texture feature is used as a key feature and a value feature, the posture feature is used as a query feature, and the cross-attention operation is performed through the noise prediction model to obtain the attention weight.

In an example, the feature fusion network is composed of a plurality of sub-layers, which are respectively a space mapping layer, a cross-attention layer, a weight mapping layer, and a weighting operation layer. The space mapping layer includes three parameter matrices, which are respectively a query space parameter matrix, a key space parameter matrix, and a value space parameter matrix. Matrix elements in the three parameter matrices are determined through pre-training. Correspondingly, the posture feature of the body part posture information is mapped to a query space through the query space parameter matrix in the space mapping layer, to obtain a corresponding query matrix. The texture feature of the body part texture image is mapped to a key space through the key space parameter matrix in the space mapping layer, to obtain a corresponding key feature. The texture feature of the body part texture image is mapped to a value space through the value space parameter matrix in the space mapping layer, to obtain a corresponding value feature.

As described above, after the texture feature of the body part texture image is mapped to the key space and the value space, and the posture feature of the body part posture information is mapped to the query space, an attention distribution matrix corresponding to the query feature is further obtained through the cross-attention layer based on the value feature and the key feature that correspond to the texture feature of the body part texture image. The attention distribution matrix is configured to describe an attention distribution corresponding to the query feature. The operation performed through cross-attention may be represented as:

$${A}_{mix} = \frac{{Q ( K )}^{T}}{\sqrt{d k}}$$

where Aₘᵢₓ represents the attention distribution matrix, Q represents a query feature obtained by mapping a posture feature to a query space, K represents the key feature obtained by mapping the texture feature to the key space, T represents transposition, and \sqrt{dk} represents a quantity of feature dimensions of the key feature.

As described above, after the attention distribution matrix is obtained, the attention distribution matrix is further mapped to the attention weight through the weight mapping layer. An operation performed by the weight mapping layer may be represented as:

$${W}_{A} = Softmax ( {A}_{mix} )$$

where W_{A} represents the attention weight, and Softmax( ) represents a normalized exponential function, which is configured to map to an interval of (0, 1) to represent weights, matrix elements in Aₘᵢₓ that represent an attention magnitude.

Finally, through the weighting operation layer, the weighting operation is performed on the attention weight and value features obtained through mapping of texture features, to obtain the fused feature, which may be expressed as:

$${F}_{fusion} = {W}_{A} * V$$

where F_{fusion} represents the fused feature, and V represents the value feature obtained through mapping of the texture features.

In some embodiments, the body part image is generated through the noise prediction model. The method further includes: obtaining a sample body part image, and obtaining a sample body part texture image and sample body part posture information that correspond to the sample body part image; selecting a sample time step, and performing sampling based on the sample body part image to obtain sample Gaussian noise corresponding to the sample time step; obtaining sample Gaussian noise of the sample body part image at the sample time step through the noise prediction model based on the sample body part texture image and the sample body part posture information; and updating a model parameter of the noise prediction model based on a difference between the sampled sample Gaussian noise and the predicted sample Gaussian noise.

This embodiment further provides an example of a training manner for a noise prediction model. A sample body part image, and a sample body part texture image and sample body part posture information corresponding to the sample body part image are obtained. Herein, a quantity of the obtained sample body part images and quantities of the sample body part texture images and sample body part posture information corresponding to the obtained sample body part images are not limited, and may be selected by a person skilled in the art based on actual requirements.

For the sample body part image, first, a sample time step is selected in various manners to represent a level of added noise. Then sample Gaussian noise corresponding to the sample time step is sampled based on the sample body part image. Then sample Gaussian noise of the sample body part image at a sample time step is obtained through a noise prediction model based on the sample body part texture image and the sample body part posture information. Finally, the model parameter of the noise prediction model is updated based on a difference between the sampled sample Gaussian noise and the predicted sample Gaussian noise until a first preset stop condition is satisfied. A configuration of the first preset stop condition is not specifically limited herein. For example, the first preset stop condition may be configured as convergence of the noise prediction model, or the first preset stop condition may be configured as a number of updates to the model parameter of the noise prediction model reaching a first preset number. The sample Gaussian noise may be added to the sample body part image to obtain a noise-added sample image.

In some embodiments, the body part image is generated through the noise prediction model. The method further includes: obtaining a sample body part image, and obtaining a sample body part texture image and sample body part posture information that correspond to the sample body part image; obtaining a sample Gaussian noise image; iteratively predicting sample Gaussian noise based on the sample body part texture image and the sample body part posture information, and performing iterative denoising on the sample Gaussian noise image through the iteratively predicted sample Gaussian noise to generate a sample body part image; and updating a model parameter of the noise prediction model based on a difference between the obtained sample body part image and the generated sample body part image. A configuration of the second preset stop condition is not specifically limited herein. For example, the second preset stop condition may be configured as the convergence of the noise prediction model, or the second preset stop condition may be configured as a number of updates to the model parameter of the noise prediction model reaching a second preset number.

In some embodiments, the obtaining a body part texture image includes: determining a training requirement of a target function model, and obtaining a body part texture image that meets the training requirement. The obtaining body part posture information includes: obtaining body part posture information that meets the training requirement. The method further includes: training the target function model by using the generated body part image as a training sample, and stopping the training until a third preset stop condition is satisfied.

This embodiment provides an example of an application for generating a body part image. The generated body part image is configured to train another function model.

A function model that needs to be trained is denoted as a target function model. A training requirement of the target function model is correspondingly determined. The training requirement is configured to describe at least the target function that the target function model is expected to implement, and a body part texture and a body part posture of a sample image required for implementing the target function.

Correspondingly, in this embodiment, the body part texture image that meets the training requirement and the body part posture information that meets the training requirement are obtained. For example, assuming that the target function that the target function model is expected to be implement is hand gesture recognition, a sample image required for the hand gesture recognition function needs to present a specific body part posture. Body part posture information presenting the specific body part posture is correspondingly obtained, and a body part texture image is obtained in various manners.

After a corresponding body part image is generated based on the body part texture image and the body part posture information obtained above, the generated body part image is used as a training sample to train the target function model until the third preset stop condition is satisfied. A configuration of the third preset stop condition is not specifically limited herein. For example, the third preset stop condition may be configured as the convergence of the target function model, or the third preset stop condition may be configured as a number of updates to the model parameter of the target function model reaching a second preset number. In this case, the training sample is obtained in this manner to train the target function model, so that obtaining costs of the training sample can be reduced, thereby reducing training costs of the target function model.

In some embodiments, the obtaining a body part texture image includes: obtaining a texture image at a preset body part of a performer as the body part texture image. The obtaining body part posture information includes: obtaining posture information of the preset body part of the performer as the body part posture information. The body part image generation method further includes: generating a body part map of a virtual avatar model corresponding to the performer based on the body part image; and adding the body part map to the virtual avatar model.

With the development of generative artificial intelligence technology, the applications of digital humans have expanded, for example, identity-based digital humans such as digital human news anchors, whose appearance and body part movements are all generated based on real anchors, which essentially means cloning an avatar of an anchor to broadcast news instead of real humans. Currently, in addition to the identity-based digital humans, another type of digital human form further exists, namely service-oriented digital humans, which serve both as multimedia artificial intelligence assistants and replacements for human services, and are widely applied in the financial and customer service fields, appearing as virtual customer service representatives, virtual tour guides, intelligent assistants, and virtual companions. Currently, driving manners used behind digital humans may be divided into two types: human-driven and algorithm-driven. In the human-driven manner, the digital human is driven to speak and act like a performer by using the audio and video of the performer transmitted by a video capture system based on expressions and movements of the performer collected by a motion capture device. In the algorithm-driven manner, a human model is trained through the artificial intelligence technology, and then a corresponding image and video are generated driven by text.

This embodiment provides an example of an application for generating a body part image. The generated body part image is configured to drive the digital human.

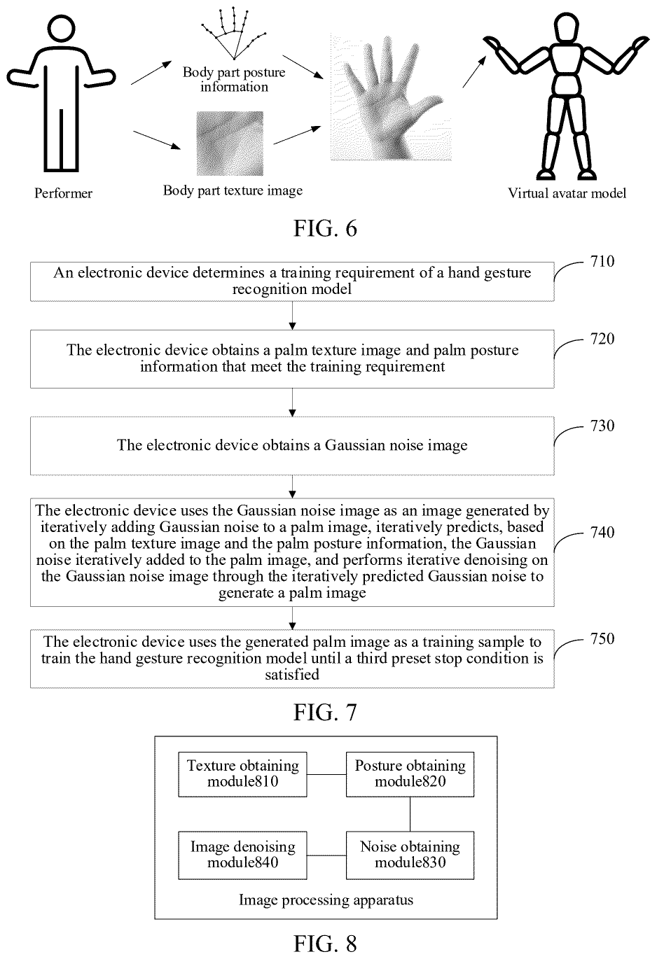

A texture image of a body part of a performer is obtained as a body part texture image, and posture information of the body part of the performer is obtained as body part posture information. For example, referring to FIG. 6, when the performer performs in reality, a body part of the performer is captured in real time through an image collection component, a captured texture image of the body part of the performer is used as a body part texture image, and movements of the body part of the performer are captured in real time through a motion capture component, to obtain body part posture information.

After the corresponding body part image is generated based on the body part texture image and the body part posture information obtained above, a body part map of a virtual avatar model corresponding to the performer is further generated based on the generated body part image, and the generated body part map is added to the virtual avatar model. In this way, a body part map matching an actual performance posture of the performer can be obtained, thereby improving a display effect of the virtual avatar model.

In some embodiments, the obtaining a body part texture image includes: obtaining a to-be-repaired object image of a target object, a body part region in the to-be-repaired object image being occluded; obtaining a historical object image corresponding to the to-be-repaired object image, a body part region in the historical object image being not occluded; and intercepting image content of the body part region in the historical object image as the body part texture image. The obtaining body part posture information includes: predicting body part posture information of the target object in the to-be-repaired object image based on historical body part posture information of the target object in the historical object image. The body part image generation method further includes: repairing the to-be-repaired object image based on the body part image, to obtain a repaired image of the target object.

This embodiment provides an example of an application for generating a body part image. The generated body part image is configured for content repairing of an image.

A to-be-repaired object image of a target object is obtained. A body part region of the target object in the to-be-repaired object image is occluded. A historical object image corresponding to the to-be-repaired object image is obtained. A body part region of the target object in the historical object image is not occluded. For example, an example in which the target object is a dance performer is used. For a shot performance video of the dance performer, a situation where body part regions of some images are occluded occurs. Correspondingly, an image with an occluded body part region may be obtained from the performance video as a to-be-repaired object image, and a historical object image without a body part region being occluded before the to-be-repaired object image is obtained. In addition, the image content intercepted from the body part region in the historical object image serves as the body part texture image. Historical body part posture information of the target object in the historical object image is obtained. Body part posture information of the target object in the to-be-repaired object image is predicted. For example, the historical body part posture information of the target object in the historical object image may be inputted to a pre-trained body part posture prediction model to perform posture prediction. The body part posture information of the target object in the to-be-repaired object image is correspondingly predicted.

After the corresponding body part image is generated based on the body part texture image and the body part posture information that are obtained above, the to-be-repaired object image is repaired based on the generated body part image. For example, image content of the body part region of the to-be-repaired object image is directly replaced with image content of the generated body part image, so as to implement repairing of the image content thereof to obtain a repaired image in which the body part region of the target object is not occluded.

It may be understood from the above that through the image processing solution provided in this disclosure, the body part texture image indicating the texture of the body part image expected to be generated is obtained, a reference body part posture texture image indicating a posture of the body part image expected to be generated is obtained, then a target image size of the body part image expected to be generated is determined, a Gaussian noise image with an image size being the target image size is obtained, finally Gaussian noise “added” to the Gaussian noise image is obtained through the noise prediction model under the guidance of the obtained body part texture image and body part posture information, and the Gaussian noise image is denoised based on the Gaussian noise to generate a corresponding body part image. In this way, a texture and a posture of a body part are decoupled and respectively used as guidance for generation of the body part image, so that the texture and the posture of the generated body part image can be effectively controlled, thereby generating a body part image having a desired posture and a desired texture, and achieving a purpose of improving flexibility of generating the body part image.

Referring to FIG. 7, the body part image generation method provided in this disclosure is described below through an example in which an electronic device is an execution subject and a body part image is a palm image. As shown in FIG. 7, a process of the body part image generation method may further be as follows.

710: An electronic device determines a training requirement of a hand gesture recognition model.

The hand gesture recognition model is a neural network model expected to perform hand gesture recognition on an image including a palm to obtain a hand gesture category of the image. A network structure of the hand gesture recognition model is not limited herein and may be configured by a person skilled in the art based on actual requirements.

The training requirement is at least configured to describe a target function that the hand gesture recognition model is expected to implement, and related description information of a sample image required for implementing the target function. A hand gesture is a posture having a specific meaning that is presented by the palm, and no special requirement is imposed on a texture of the palm. Based on this, the foregoing related description information at least specifies the gesture image of what posture to be used as the sample image, a size of the sample image, and the like. The palm texture may be restricted, or may not be restricted. Correspondingly, in this embodiment, the electronic device first determines the training requirement of the hand gesture recognition model.

720: The electronic device obtains a palm texture image and palm posture information that meet the training requirement.

As described above, based on the obtained training requirement, the electronic device further obtains a palm texture image that meets the training requirement as the palm texture image, and obtains palm posture information that meets the training requirement as the palm posture information.

A manner of obtaining the palm texture image is not specifically limited in this embodiment, which may be receiving an inputted palm texture image through an input component (such as a keyboard, a mouse, a touchscreen, or a touchpad), or may be collecting a palm texture image through an image collection component (such as a camera), or may be receiving a palm texture image sent by an external device, or the like.

In addition, a manner of obtaining the palm posture information is not specifically limited in this embodiment, which may be receiving inputted palm posture information through an input component (such as a keyboard, a mouse, a touchscreen, or a touchpad), or may be collecting palm posture information through an image collection component (such as a camera), or may be receiving palm posture information sent by an external device, or the like.

730: The electronic device obtains a Gaussian noise image.

In this embodiment, the electronic device may determine a target image size of a generated palm image based on the training requirement, and obtain a Gaussian noise image whose image size is the target image size. The target image size may include a length and a width of the generated palm image.

After determining the target image size of the palm image expected to be generated, the electronic device further obtains a Gaussian noise image whose image size is the target image size. The Gaussian noise image of the target image size may be generated in various manners. In other words, based on the target image size, a random noise matrix that follows a Gaussian distribution with a variance of 1 and a mean of 0 is generated, to obtain the Gaussian noise image of the target image size.

740: The electronic device uses the Gaussian noise image as an image generated by iteratively adding Gaussian noise to the palm image, iteratively predicts, based on the palm texture image and the palm posture information, the Gaussian noise iteratively added to the palm image, and performs iterative denoising on the Gaussian noise image through the iteratively predicted Gaussian noise to generate a palm image.

The noise prediction model is pre-trained in this embodiment. The noise prediction model is trained through a diffusion model. During the training of the noise prediction model, for a sample palm image with added Gaussian noise, the noise prediction model learns the ability to predict the added Gaussian noise based under the guidance of a sample palm texture image and sample palm posture information. In this way, in the application process, when a Gaussian noise image is inputted into the noise prediction model, the “added” Gaussian noise of the Gaussian noise image is predicted under the guidance of the palm texture image and the palm posture information. The “added” Gaussian noise is subtracted from the Gaussian noise image, so that a palm image whose texture conforms to the palm texture image and whose posture conforms to the palm posture information can be reconstructed.

Correspondingly, after the palm texture image indicating the texture of the palm image expected to be generated, reference posture information indicating a posture of the palm image expected to be generated, and the Gaussian noise image with the target image size are obtained, the electronic device uses the palm texture image and the palm posture information as guidance. Through the pre-trained noise prediction model, the “added” Gaussian noise of the Gaussian noise image is predicted and denoted as Gaussian noise, and based on the Gaussian noise, the Gaussian noise image is denoised, i.e., the “added” Gaussian noise is subtracted therefrom, thereby obtaining a palm image whose texture conforms to the palm texture image and whose posture conforms to the palm posture information.

750: The electronic device uses the generated palm image as a training sample to train the hand gesture recognition model until a third preset stop condition is satisfied.

As described above, after the palm image is generated, the electronic device uses the generated body part image as the training sample to train the hand gesture recognition model until the third preset stop condition is satisfied. A configuration of the third preset stop condition is not specifically limited herein. For example, the third preset stop condition may be configured as the convergence of the hand gesture recognition model, or the third preset stop condition may be configured as a number of updates to the model parameter of the hand gesture recognition model reaching a second preset number. In this case, the training sample is obtained in this manner to train the hand gesture recognition model, so that obtaining costs of the training sample can be reduced, thereby reducing training costs of the hand gesture recognition model.

To better implement the foregoing body part image generation method, an embodiment of this disclosure further provides a corresponding body part image generation apparatus. Nouns in this embodiment have the same meanings as those in the foregoing body part image generation methods. For specific implementation details, reference is made to the descriptions in the foregoing method embodiments.

FIG. 8 is a schematic structural diagram of a body part image generation apparatus according to an embodiment of this disclosure. The body part image generation apparatus may include a texture obtaining module 810, a posture obtaining module 820, a noise obtaining module 830, and an image denoising module 840.

The texture obtaining module 810 is configured to obtain a body part texture image, the body part texture image indicating a texture of a body part image expected to be generated.

The posture obtaining module 820 is configured to obtain body part posture information, the body part posture information indicating a posture of the body part image expected to be generated.

The noise obtaining module 830 is configured to obtain a Gaussian noise image.

The image denoising module 840 is configured to iteratively predict Gaussian noise based on the body part texture image and the body part posture information, and perform iterative denoising on the Gaussian noise image through the iteratively predicted Gaussian noise to generate a body part image.

In some embodiments, the noise obtaining module 830 may be configured to determine a target image size of the body part image expected to be generated; and obtain the Gaussian noise image based on the target image size, an image size of the Gaussian noise image being consistent with the target image size.

In some embodiments, the image denoising module 840 is configured to extract a texture feature of the body part texture image, and extract a posture feature of the body part posture information; and iteratively predict the Gaussian noise based on the texture feature and the posture feature, and perform iterative denoising on the Gaussian noise image through the iteratively predicted Gaussian noise to generate the body part image.

In some embodiments, the image denoising module 840 is configured to: fuse the texture feature and the posture feature to obtain a fused feature; predict Gaussian noise of the Gaussian noise image at a T^{th} time step based on the fused feature, and denoise the Gaussian noise image based on the Gaussian noise at the T^{th} time step to obtain a denoised image at a (T−1)^{th} time step, T being a positive integer greater than 1; predict Gaussian noise at a t^{th} time step of a denoised image at the t^{th} time step based on the fused feature, and denoise the denoised image at the t^{th} time step based on the Gaussian noise at the t^{th} time step to obtain a denoised image at a (t−1)^{th} time step, t∈[1, T−1]; and obtain the body part image based on a denoised image at a 0^{th} time step.

In some embodiments, the image denoising module 840 is configured to perform a cross-attention operation based on the texture feature and the posture feature to obtain an attention weight; and perform a weighting operation on the texture feature based on the attention weight to obtain the fused feature.

In some embodiments, the image denoising module 840 is configured to perform the cross-attention operation by using the texture feature as a key feature and a value feature and using the posture feature as a query feature, to obtain the attention weight.

In some embodiments, the body part image is generated through a noise prediction model. The body part image generation apparatus provided in this disclosure further includes a first model training module, configured to: obtain a sample body part image, and obtain a sample body part texture image and sample body part posture information that correspond to the sample body part image; select a sample time step, and perform sampling based on the sample body part image to obtain sample Gaussian noise corresponding to the sample time step; obtain sample Gaussian noise of the sample body part image at the sample time step through the noise prediction model based on the sample body part texture image and the sample body part posture information; and update a model parameter of the noise prediction model based on a difference between the sampled sample Gaussian noise and the predicted sample Gaussian noise.

In some embodiments, the body part image is generated through the noise prediction model. The body part image generation apparatus provided in this disclosure further includes a second model training module, configured to: obtain a sample body part image, and obtain a sample body part texture image and sample body part posture information that correspond to the sample body part image; obtain a sample Gaussian noise image; iteratively predict sample Gaussian noise based on the sample body part texture image and the sample body part posture information, and perform iterative denoising on the sample Gaussian noise image through the iteratively predicted sample Gaussian noise to generate a sample body part image; and update a model parameter of the noise prediction model based on a difference between the obtained sample body part image and the generated sample body part image.

In some embodiments, the texture obtaining module 810 is configured to determine a training requirement of a target function model, and obtain a body part texture image that meets the training requirement.

The posture obtaining module 820 is configured to obtain the body part posture information that meets the training requirement.

The body part image generation apparatus provided in this disclosure further includes a third model training module, configured to train the target function model by using the generated body part image as a training sample, and stop the training until a third preset stop condition is satisfied.

In some embodiments, the texture obtaining module 810 is configured to obtain a texture image at a preset body part of a performer as the body part texture image.

The posture obtaining module 820 is configured to obtain posture information of the preset body part of the performer as the body part posture information.

The body part image generation apparatus provided in this disclosure further includes a mapping module, configured to generate a body part map of a virtual avatar model corresponding to the performer based on the body part image; and add the body part map to the virtual avatar model.

In some embodiments, the texture obtaining module 810 is configured to: obtain a to-be-repaired object image of a target object, a body part region in the to-be-repaired object image being occluded; obtain a historical object image corresponding to the to-be-repaired object image, a body part region in the historical object image being not occluded; and intercept image content of the body part region in the historical object image as the body part texture image.

The posture obtaining module 820 is configured to predict body part posture information of the target object in the to-be-repaired object image based on historical body part posture information of the target object in the historical object image.

The body part image generation apparatus provided in this disclosure further includes a repairing module, configured to repair the to-be-repaired object image based on the body part image, to obtain a repaired image of the target object.

For specific implementation of the foregoing modules, reference may be made to the foregoing embodiments, and details are not described herein again.

An embodiment of this disclosure further provides an electronic device, including a memory and processing circuitry (e.g., a processor), the processing circuitry being configured to perform, by invoking a computer program stored in the memory, the operations in the body part image generation methods provided in the foregoing embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

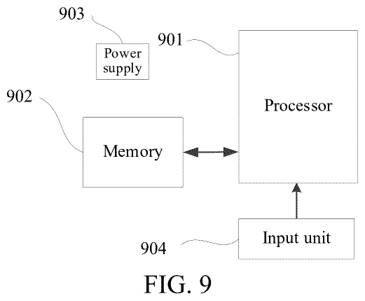

FIG. 9 is a schematic structural diagram of an electronic device according to an embodiment of this disclosure.

The electronic device may include components such as a processing unit 901 with one or more processing cores, a memory 902 with one or more computer-readable storage media, a power supply 903, and an input unit 904. A person skilled in the art may understand that a structure of the electronic device shown in FIG. 9 does not constitute a limitation on the electronic device, and the electronic device may include more or fewer components than those shown in the figure, or some merged components, or different component arrangements.

Processing circuitry, such as the processor 901, is a control center of the electronic device, is connected to various parts of the entire electronic device by using various interfaces and lines, and implements various functions of the electronic device and processes data by running or executing a computer program and/or module stored in the memory 902 and invoking data stored in the memory 902. In some embodiments, the processor 901 may include one or more processing cores. In some embodiments, the processor 901 may integrate an application processor and a modem processor. The application processor mainly processes an operating system, a user interface, an application program, and the like, and the modem processor mainly processes wireless communication. The foregoing modem may not be integrated into the processor 901.

The memory 902 may be configured to store a software program and a module, and the processor 901 executes various function applications and performs data processing by running the software program and the module stored in the memory 902. The memory 902 may mainly include a program storage area and a data storage area. The program storage area may store an operating system, an application program required by at least one function (such as a sound playback function and an image display function), and the like. The data storage area may store data created based on use of an electronic device, and the like. In addition, the memory 902 may include a high-speed random access memory (RAM), and may further include a non-volatile memory, such as at least one magnetic disk storage device, a flash memory device, or another volatile solid-state storage device. Correspondingly, the memory 902 may further include a memory controller, to provide access to the memory 902 for the processor 901.

The electronic device further includes the power supply 903 that supplies power to each component. In some embodiments, the power supply 903 may be logically connected to the processor 901 through a power management system, so that functions such as charging, discharging, and power management can be achieved through the power management system. The power supply 903 may further include any component such as one or more direct current or alternating current power supplies, a recharging system, a power failure detection circuit, a power converter or inverter, and a power status indicator.

The electronic device may further include the input unit 904. The input unit 904 may be configured to receive an inputted number or character information, and generate a keyboard, a mouse, a joystick, or an optical or trackball signal input related to user settings and function control.

Although not shown, the electronic device may further include a display unit, an image collection component, and the like. Details are not described herein again. Specifically, in this embodiment, the processor 901 loads executable code corresponding to one or more computer programs into the memory 902, and the processor 901 performs the operations in the body part image generation methods provided in this disclosure, for example, obtaining a body part texture image, the body part texture image indicating a texture of a body part image expected to be generated; obtaining body part posture information, the body part posture information indicating a posture of the body part image expected to be generated; obtaining a Gaussian noise image; and iteratively predicting Gaussian noise based on the body part texture image and the body part posture information, and performing iterative denoising on the Gaussian noise image through the iteratively predicted Gaussian noise, to generate the body part image.

The electronic device provided in the embodiments of this disclosure and the body part image generation methods in the foregoing embodiment belong to the same concept. For the specific implementation process, reference is made to the foregoing relevant embodiments. Details are not described herein again.

This disclosure further provides a computer-readable storage medium, such as a non-transitory computer-readable storage medium, having a computer program stored therein. When the computer program stored therein is executed on the processor of the electronic device provided in the embodiments of this disclosure, the processor of the electronic device implements the operations in the body part image generation methods provided in this disclosure. The medium may include a magnetic disc, an optical disc, a read-only memory (ROM), a RAM, or the like.

This disclosure further provides a computer program product. The computer program product includes a computer program. When the computer program is executed on the processor of the electronic device provided in this embodiment of this disclosure, the processor of the electronic device implements the operations in the body part image generation methods provided in this disclosure.

The foregoing has provided a detailed description of the body part image generation method, the body part image generation apparatus, the electronic device, the computer-readable storage medium, and the computer program product provided in this disclosure. Although the principles and implementations of this disclosure are described through specific examples in this specification, the foregoing descriptions of the embodiments are merely intended to help understand the method and core idea of this disclosure. Moreover, a person skilled in the art may make modifications to the specific implementations and application range according to the idea of this disclosure. Based on the above, the content of this specification is not to be construed as a limitation on this disclosure.

What is claimed is:

1. A body part image generation method, comprising:
obtaining a body part texture image indicating a texture of a body part in a body part image to be generated;
obtaining body part posture information indicating a posture of the body part in the body part image to be generated;
obtaining a Gaussian noise image;
iteratively predicting Gaussian noise based on the body part texture image and the body part posture information; and
generating, by processing circuitry, the body part image through iterative denoising of the Gaussian noise image based on the iteratively predicted Gaussian noise.

2. The method according to claim 1, wherein the obtaining the Gaussian noise image comprises:
determining a target image size of the body part image to be generated; and
obtaining the Gaussian noise image based on the target image size, an image size of the Gaussian noise image being the target image size.

3. The method according to claim 1, wherein the iteratively predicting comprises:
extracting a texture feature of the body part texture image;
extracting a posture feature of the body part posture information; and
iteratively predicting the Gaussian noise based on the texture feature and the posture feature.

4. The method according to claim 3, wherein
the iteratively predicting comprises:
fusing the texture feature and the posture feature to obtain a fused feature;
predicting Gaussian noise of the Gaussian noise image at a T^{th} time step based on the fused feature;
predicting Gaussian noise at a t^{th} time step of a denoised image at a t^{th} time step based on the fused feature, and
the generating comprises:
denoising the Gaussian noise image based on the Gaussian noise at the T^{th} time step, to obtain a denoised image at a (T−1)^{th} time step, T being a positive integer greater than 1;
denoising the denoised image at the t^{th} time step based on the Gaussian noise at the t^{th} time step, to obtain a denoised image at a (t−1)^{th} time step, t∈[1, T−1]; and
obtaining the body part image based on a denoised image at a 0^{th} time step.

5. The method according to claim 4, wherein the fusing comprises:
performing a cross-attention operation based on the texture feature and the posture feature to obtain an attention weight; and
performing a weighting operation on the texture feature based on the attention weight, to obtain the fused feature.

6. The method according to claim 5, wherein the performing the cross-attention operation comprises:
performing the cross-attention operation by using the texture feature as a key feature and a value feature and using the posture feature as a query feature, to obtain the attention weight.

7. The method according to claim 1, wherein the body part image is generated through a noise prediction model, and the method further comprises:
obtaining a sample body part image;
obtaining a sample body part texture image and sample body part posture information that correspond to the sample body part image;
selecting a sample time step;
obtaining sample Gaussian noise corresponding to the sample time step through sampling based on the sample body part image;
obtaining the sample Gaussian noise of the sample body part image at the sample time step through the noise prediction model based on the sample body part texture image and the sample body part posture information; and
updating a model parameter of the noise prediction model based on a difference between the sampled sample Gaussian noise and the predicted sample Gaussian noise.

8. The method according to claim 1, wherein the body part image is generated through a noise prediction model, and the method further comprises:
obtaining a sample body part image;
obtaining a sample body part texture image and sample body part posture information that correspond to the sample body part image;
obtaining a sample Gaussian noise image;
iteratively predicting sample Gaussian noise based on the sample body part texture image and the sample body part posture information;
performing iterative denoising on the sample Gaussian noise image through the iteratively predicted sample Gaussian noise to generate a sample body part image; and
updating a model parameter of the noise prediction model based on a difference between the obtained sample body part image and the generated sample body part image.

9. The method according to claim 1, wherein
the obtaining the body part texture image comprises
determining a training requirement of a target function model, the training requirement indicating a specific body part posture, and
obtaining the body part texture image that meets the training requirement;
the obtaining the body part posture information comprises
obtaining the body part posture information that meets the training requirement; and
the method further comprises
training the target function model by using the generated body part image as a training sample until a stop condition is satisfied.

10. The method according to claim 1, wherein the obtaining the body part texture image comprises:
obtaining the body part texture image based on a texture image at a predetermined body part of a subject.

11. The method according to claim 10, wherein the obtaining the body part posture information comprises:
obtaining the body part posture information based on a posture of the predetermined body part of the subject.

12. The method according to claim 10, further comprising:
generating a body part map corresponding to a virtual avatar model of the subject based on the body part image; and
adding the body part map to the virtual avatar model.

13. The method according to claim 1, wherein the obtaining the body part texture image comprises
obtaining a to-be-repaired object image of a target object, a body part region in the to-be-repaired object image being occluded,
obtaining a historical object image corresponding to the to-be-repaired object image, a body part region in the historical object image not being occluded, and
capturing image content of the body part region in the historical object image as the body part texture image; and
the method further includes repairing the to-be-repaired object image based on the body part image.

14. The method according to claim 13, wherein the obtaining the body part posture information comprises:
predicting body part posture information of the target object in the to-be-repaired object image based on historical body part posture information of the target object in the historical object image.

15. An information processing apparatus, comprising:
processing circuitry configured to:
obtain a body part texture image indicating a texture of a body part in a body part image to be generated;
obtain body part posture information indicating a posture of the body part in the body part image to be generated;
obtain a Gaussian noise image;
iteratively predict Gaussian noise based on the body part texture image and the body part posture information; and
generate the body part image through iterative denoising of the Gaussian noise image based on the iteratively predicted Gaussian noise.

16. The information processing apparatus according to claim 15, wherein the processing circuitry is configured to:
determine a target image size of the body part image to be generated; and
obtain the Gaussian noise image based on the target image size, an image size of the Gaussian noise image being the target image size.

17. The information processing apparatus according to claim 15, wherein the processing circuitry is configured to:
extract a texture feature of the body part texture image;
extract a posture feature of the body part posture information; and
iteratively predict the Gaussian noise based on the texture feature and the posture feature.

18. The information processing apparatus according to claim 17, wherein the processing circuitry is configured to:
fuse the texture feature and the posture feature to obtain a fused feature;
predict Gaussian noise of the Gaussian noise image at a T^{th} time step based on the fused feature;
denoise the Gaussian noise image based on the Gaussian noise at the T^{th} time step, to obtain a denoised image at a (T−1)^{th} time step, T being a positive integer greater than 1;
predict Gaussian noise at a t^{th} time step of a denoised image at the t^{th} time step based on the fused feature;
denoise the denoised image at the t^{th} time step based on the Gaussian noise at the t^{th} time step, to obtain a denoised image at a (t−1)^{th} time step, t∈[1, T−1]; and
obtain the body part image based on a denoised image at a 0^{th} time step.

19. The information processing apparatus according to claim 18, wherein the processing circuitry is configured to:
perform a cross-attention operation based on the texture feature and the posture feature to obtain an attention weight; and
perform a weighting operation on the texture feature based on the attention weight, to obtain the fused feature.

20. A non-transitory computer-readable storage medium storing instructions which when executed by at least one processor cause the at least one processor to perform a body part image generation method, comprising:
obtaining a body part texture image indicating a texture of a body part in a body part image to be generated;
obtaining body part posture information indicating a posture of the body part in the body part image to be generated;
obtaining a Gaussian noise image;
iteratively predicting Gaussian noise based on the body part texture image and the body part posture information; and
generating, by processing circuitry, the body part image through iterative denoising of the Gaussian noise image based on the iteratively predicted Gaussian noise.
